(19) United States
(12) Patent Application Publication
(10) Pub. No.: US 2025/0306558 A1
(43) Pub. Date: Oct. 2, 2025

(54) INTRINSICALLY SAFE AUTOMATION FIELD DEVICE

(71) Applicant: Endress+Hauser SE+Co. KG, Maulburg (DE)

(72) Inventors: Christian Strittmatter, Rickenbach (DE); Simon Gerwig, Schopfheim (DE); Pascal Mutter, Waldshut-Tiengen (DE)

(21) Appl. No.: 18/847,508

(22) PCT Filed: Mar. 7, 2023
(86) PCT No.: PCT/EP2023/055691

§ 371 Date: Sep. 16, 2024

(30) Foreign Application Priority Data
Mar. 23, 2022 (DE) 10 2022 106 846.3

(51) Int. Cl. G05B 19/042

(52) U.S. Cl. CPC G05B 19/0428; G05B 2219/25196; G05B 2219/25318

(57) ABSTRACT

An intrinsically safe automation field device for use in a potentially explosive area comprises a first and a second connection terminal for connecting a two-wire line that can be used to supply a current; a sensor and/or actuator module for capturing and/or setting a process variable; an input/output module having a radio unit for wirelessly transmitting data; and a main electronics module which is separate from the input/output module and has an energy store which is designed to provide energy needed for the radio unit for wirelessly transmitting data, wherein at least the energy store is encapsulated on the main electronics module using a potting compound.

The invention relates to an intrinsically safe automation field device for use in a potentially explosive area.

In automation, field devices serving to record and/or modify process variables are frequently used, particularly in process automation. Sensors, such as fill-level measuring devices, flow meters, pressure and temperature measuring devices, pH redox potential meters, conductivity meters etc., are used for recording the respective process variables, such as fill level, flow, pressure, temperature, pH level, and conductivity. Actuators, such as, for example, valves or pumps, are used to influence process variables. The flow rate of a fluid in a pipeline section or a fill-level in a container can thus be altered by means of actuators. In principle, all devices that are used in-process and that supply or process process-relevant information are referred to as field devices. In the context of the invention, field devices also include remote I/Os, radio adapters, and/or, in general, devices that are arranged at the field level.

A variety of such field devices is manufactured and marketed by the Endress+Hauser company.

In particular in the process industry, but also in automation, physical or technical variables must often be measured or determined by the field devices in regions in which there is potentially a risk of explosion, so-called potentially explosive areas. By means of suitable measures in the field devices and evaluation systems (e.g. voltage and current limitation), the electrical power in the signal to be transmitted can be limited such that this signal cannot trigger an explosion under any circumstances (short-circuit, interruptions, thermal effects, etc.). For this purpose, corresponding protection principles have been defined in IEC EN DIN 60079 ff.

According to this standard, design and circuitry measures for the field devices for use in potentially explosive areas are defined on the basis of the ignition protection types to be applied. One of these ignition protection types represents the ignition protection type “intrinsic safety” (identification code Ex-i, IEC EN DIN 60079-11, published June 2012).

The ignition protection type “intrinsic safety” is based on the principle of limiting current and voltage in a circuit. The power in the circuit which could be capable of igniting an explosive atmosphere is limited such that the surrounding explosive atmosphere cannot be ignited either by sparks or by impermissible heating of the electrical components.

The ignition protection type “intrinsic safety” defines three protection levels: Ex-ia, Ex-ib and Ex-ic. In this case, the highest level is defined by level a, at which two countable faults in their combination do not lead to a malfunction and thus cause ignition (2-fault safety). Level b defines that one countable fault does not lead to a malfunction and thus cause an ignition (1-fault safety). In the case of level c, no error safety is defined, so that, in the case of one malfunction, an ignition can already be triggered (0-fault safety).

Nowadays, field devices are made up of modular field device electronics that are electrically connected to one another via a plug connection and arranged in a corresponding housing. The modular design allows the individual electronic modules to be prefabricated according to the intended functionality and then assembled to form the field device electronics. Common modules that are connected via the plug connection are: a main electronics module, which has, for example, a microprocessor for further data processing, a sensor and/or actuator module, which comprises a sensor and/or actuator element for capturing and/or setting the physical variable, and an input/output module, which comprises, for example, a display for displaying information. Since the input/output module is arranged behind a viewing window in a housing wall so that the display can be read and thus interference with the radio transmission through the housing wall can be reduced, the input/output module also usually comprises a radio unit.

Many field devices are designed as so-called 2-wire field devices. Power is here supplied to the field device by means of the same pair of lines (two-wire line) used for communication. The 4-20 mA standard is usually used for this, in which the measurement or control values as a main process variable are communicated, i.e. transmitted, in analog form via the two-wire line or two-wire cable as a 4-20 mA loop current or current signal. Here, an electrical loop current between 4 mA and 20 mA flowing in a current loop represents the value of the physical or technical quantity. Due to drifts and inaccuracies as well as the detection of range overflows, a slightly larger current range is permitted for the representation of the variables: 3.8 . . . 20.5 mA. Currents that are smaller than 3.6 mA or larger than 21 mA should no longer be interpreted by the evaluation units as a representation of the physical or technical variable, but as error information of the sensor.

This means that the energy supply is severely limited. Assuming the “worst case” scenario, in which the field device signals an error condition and is therefore only supplied with a current of less than 3.6 mA, the field device has an energy of less than 38.16 mW (=10.6 V*3.6 mA) available at a supply voltage of 10.6 V.

In order to allow for radio communication through the field devices, e.g., through a Bluetooth radio unit, a higher energy is required, at least temporarily, than the energy currently available. For this purpose, an energy store is usually provided on the input/output module of the field device, in which energy is continuously stored so that it is available for sending and/or receiving communication packets by the radio unit.

Since such energy stores must be able to store a relatively large amount of energy, they are encapsulated with a potting compound in order to be able to use the field device in the explosion region. Encapsulation is carried out using a potting frame, which surrounds the energy stores and is filled with the potting compound. The disadvantage of this is that an additional process step is necessary during the production of the input/output module for applying the potting frame and filling the potting compound. This additional process step results in additional costs.

A further disadvantage is that the energy store represents a short circuit for the main electronics module when the device is switched on or when the input/output module is plugged in (hot-plug) into a corresponding interface of the main electronics module and thus draws a lot of energy from the main electronics module. This would mean that the main electronics module would not be able to perform its function for a short time. To avoid this, an additional (active) current limiter is integrated on the input/output module in front of the energy store, which limits or regulates the current at the start-up moment. This additional circuit component also results in additional material and production costs.

The invention is therefore based on the object of providing a remedy for this.

The object is achieved according to the invention by the intrinsically safe automation field device according to claim 1.

The intrinsically safe automation field device according to the invention for use in a potentially explosive area comprises:
a first and a second connection terminal for connecting a two-wire line that can be used to supply a current;
a sensor and/or actuator module for capturing and/or setting a process variable;
an input/output module having a radio unit for wireless data transmission;
a main electronics module connected to the first and second connection terminals and designed separately at least from the input/output module, which carries the current that can be supplied via the two-wire line via a current path from the first to the second connection terminal, wherein the main electronics module has a voltage regulator introduced into the current path, which is designed to provide a power supply at least for the input/output module based on the supplied current, wherein the main electronics module is further designed to transmit the process variable detected via the sensor element by setting the current to a corresponding value and/or to receive a process variable to be set by the actuator element by reading the current and to set the actuator element accordingly, wherein the main electronics module further has an energy store that is designed to provide energy required for the radio unit for wirelessly transmitting data, wherein at least the energy store on the main electronics module is encapsulated using a potting compound.

An intrinsically safe automation field device designed according to the invention offers the advantage that additional potting of the energy store on the input/output module using a potting frame is no longer necessary. This in turn means that space can be saved on the input/output module, thus reducing the manufacturing costs of the module.

An advantageous embodiment of the field device according to the invention for automation technology provides that the energy store has at least one capacitor which has a capacitance of at least 10 μF, preferably of at least 250 μF, particularly preferably of at least 1 mF.

A further advantageous embodiment of the field device according to the invention in automation technology provides that the energy store is arranged in front of the voltage regulator on the main electronics module.

A further advantageous embodiment of the field device according to the invention in automation technology provides that the input/output module further comprises a current limiter or regulator which limits a current from the main electronics module to a value in the range of 0.1-100 mA, in particular in the range of 0.1-25 mA, very particularly in the range of 1-5 mA 10-100 mA.

A further advantageous embodiment of the field device according to the invention in automation technology provides that the input/output module does not have a capacitor with a capacitance of greater than 100 μF, in particular of approximately 500 μF.

A further advantageous embodiment of the field device according to the invention in automation technology provides that the input/output module and the main electronics module are connected to one another via an electrical interface, which is preferably designed to be pluggable.

A further advantageous embodiment of the field device according to the invention in automation technology provides that the input/output module is arranged in a cover of the field device, preferably behind a viewing window.

A further advantageous embodiment of the field device according to the invention in automation technology provides that the input/output module further comprises a display for displaying information and/or for operating the field device.

A further advantageous embodiment of the field device according to the invention in automation technology provides that the display is a color display.

The invention is explained in more detail based upon the following drawing. In the drawings:

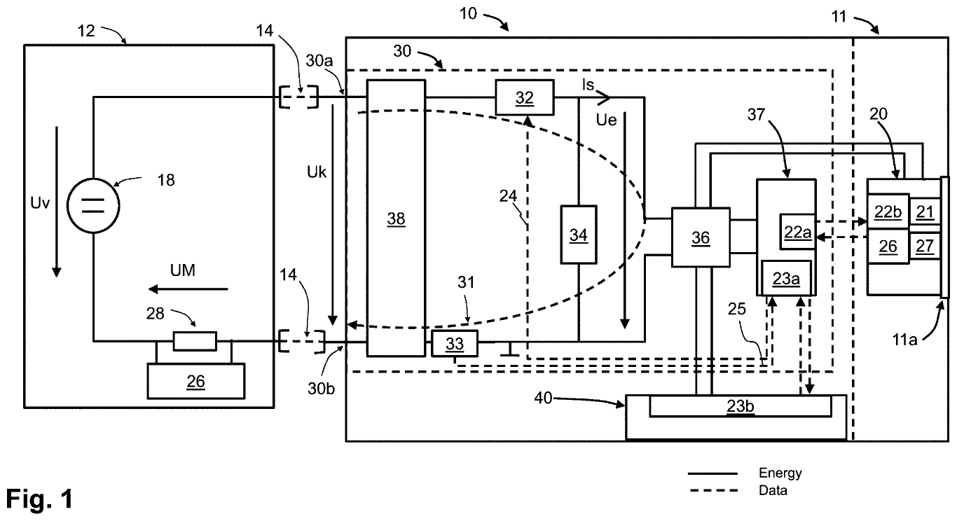

FIG. 1 shows a schematic representation of a field device which is connected to a higher-level unit via a two-wire line for signal and power transmission.

FIG. 1 shows a schematic representation of a field device 10 with modular field device electronics. In this example, the field device electronics comprises a main electronics module 30, a sensor module 40 and an input/output module 20. The input/output module 20 and the sensor module 40 are each electrically connected to the main electronics module 30 via an interface 22a, 22b and 23a, 23b, which can be designed, for example, as a plug-in connection. The field device 10 is connected to a two-wire line 14 for signal and power transmission via a first and second connection terminal 30a and 30b. The two-wire line 14 is in turn connected at the other end to a higher-level unit 12. In the example shown, the field device 10 is a measuring point in which a measured value or process variable (for example temperature, pressure, humidity, fill level, flow) is captured with the aid of a sensor module 40. However, the field device could also be an actuator point in which a process variable is set with the aid of an actuator module instead of the sensor module.

The field device 10 does not contain its own power source, but rather draws the supply current required for its operation via the two-wire line 14. This can be provided, for example, by a voltage source 18 contained in the higher-level unit 12. A measured value signal representing the measured value just measured is transmitted from the field device 10 to the higher-level unit 12 via the same two-wire line 14. For this purpose, the field device electronics are designed to transmit a measured value via the two-wire line 14 in accordance with the 4 to 20 mA standard. The voltage source 18 supplies a DC voltage Uv, and the measuring current Is is a direct current.

The higher-level unit 12 contains an evaluation circuit 26 which obtains the measured value information from the signal current Is transmitted via the two-wire line 14. For this purpose, a measuring resistor 28 is inserted into the two-wire line, at which a voltage UM is generated, which is proportional to the signal current Is transmitted via the two-wire line and which is supplied to the evaluation circuit 26. The signal current Is is guided in the field device 10 by a current path 31 formed on the main electronics module from the first to the second connection terminal 30a, 30b.

The input/output module 20 comprises, as already mentioned, the radio unit 21 for wirelessly transmitting and receiving data. For example, the radio unit 21 can be a Bluetooth radio unit for wirelessly transmitting data using the Bluetooth standard or a modified variant thereof, e.g., Bluetooth Low Energy. Alternatively, the radio module can also be a WLAN, ZigBee, NFC, IIoT, 5G or WirelessHART radio module. The data may, for example, be configuration and/or parameterization data for the field device. Furthermore, the input/output module can have a display 27 for displaying information and/or for operating the field device. The display 27 can, for example, be a color display. In the case that the display 27 is a monochrome display, a charge pump can also be provided on the input/output module 20, which serves to control the monochrome display. In the case that the display 27 is a color display, the input/output module 20 does not have a charge pump.

For measuring value acquisition, the field device electronics comprises the already mentioned sensor module 40, which is connected to the main electronics module 30 via the electrical interface 23a, 23b. The electrical interface 23a, 23b can be designed as a pluggable interface. Via the electrical interface 23a, 23b, both measured values of the sensor module to the main electronics module 30 and energy to the sensor module 40 from the main electronics module 30 are transmitted. The electrical interface 23a, 23b can be designed as a pluggable electrical interface.

The main electronics module in turn comprises a measuring transducer circuit 37 which, via a control line 24, controls or regulates a current regulator or current source 32, which is also arranged on the main electronics module, in such a way that the measuring current Is is set to a value (signal current) representing the measured value recorded. The current source 32 can comprise, for example, a transistor which is regulated by the control signal from the measuring transducer circuit 37. In the case where the field device is designed as an actuator, i.e., has an actuator module instead of a sensor module, the current regulator is omitted. The measuring transducer circuit 37 may, for example, comprise a microprocessor.

The main electronics module further comprises a low-impedance shunt resistor 33, via which the signal current Is is read back through the measuring transducer circuit 37 by means of a read-back line 25. According to Ohm's law, a voltage U_shunt=R_shunt. Is drops at the shunt resistor 33. The voltage U_shunt is thus proportional to the current Is flowing through the field device. In order to regulate the signal current Is to be set, the voltage dropping across the shunt resistor 33 is supplied to the measuring transducer circuit. Such shunt resistors 33 typically have a resistance value in the range of 5-40 ohms, preferably 7-30 ohms, particularly preferably in the range of 10-25 ohms.

The main electronics module further comprises a voltage regulator 36, for example in the form of a switching or linear regulator, which is designed to provide the most constant operating voltage possible for the individual modules. The input voltage for the voltage regulator 36 can, for example, be stabilized or supported by an energy store 34, in particular in the form of a capacitor. The energy store 34 can, for example, have a capacitance of at least 10 μF, preferably of at least 250 μF, particularly preferably of at least 1 mF. For reasons of clarity, the voltage source arranged on the main electronics module 30 is not shown in FIG. 1.

Furthermore, the main electronics module has circuit components for explosion protection and/or EMC measures. In FIG. 1, these circuit parts are indicated by way of example by the block with the reference sign 38. Depending on the desired level of protection and the specifications of the corresponding standard, e.g. IEC EN DIN 60079-11, published June 2012, with regard to explosion protection measures and/or e.g. the standard DIN EN 61000-1-2, published July 2017, with regard to EMC measures, the circuit parts are designed differently.

According to the invention, the main electronics module further comprises an energy store which is designed to continuously store energy which is transmitted via the two-wire line 14 and, if required, to deliver this energy to a radio unit arranged on another module of the field device electronics for wireless data transmission during a transmission or reception process. In this case, the radio unit 21 is located on the input/output module. The energy store 34 can be, for example, a capacitor, which preferably has a capacitance that is greater than 100 μF, preferably approximately 500 μF.

Advantageously, the energy store 34 is arranged on the main electronics module 30 in such a way that it is arranged in front of the voltage regulator 36, so that the energy store 34 is supplied with a higher voltage than would be the case with an arrangement after the voltage regulator 36. This offers the advantage that significantly more energy can be stored in the energy store, since the voltage is quadratically proportional to the amount of energy to be stored (E=½*C*U²). Thus, when arranged in front of the voltage regulator 36, the capacitance can be reduced since the amount of energy required for the transmission and/or reception process does not change.

In order to meet the requirements of the intrinsic safety type of protection, at least the energy store 34 on the main electronics module 30 is encapsulated using a potting compound. Usually, however, at least the voltage regulator, the current regulator, and the energy store or all electronic components on the main electronics module are encapsulated using the potting compound.

In order to be able to transmit the required current from the main electronics module 30 to the module on which the radio unit 21 is arranged during a transmission and/or reception process by the radio unit 21, a current limiter or regulator 26 can be provided on the module and designed in such a way that a current required for the transmission and/or reception process, which is, for example, in the range of approximately 10-100 mA, can flow.

### LIST OF REFERENCE SIGNS

10 Field device
11 Cover of the field device
11a Viewing window
12 Higher-level unit, e.g. programmable logic controller (PLC)
14 Two-wire line
18 Voltage source
20 Input/output module
21 Radio unit
22a, 22b Electrical interface
23a, 23b Electrical interface
24 Control line
25 Read-back line
26 Current limiter or regulator
27 Display
28 Measuring resistance
30 Main electronics module
30a, 30b Connection terminal
31 Current path
32 Current regulator
33 Shunt resistor
34 Energy store, e.g., capacitor
36 Voltage regulator, e.g. switching regulator or linear regulator
37 Transducer circuit
38 Circuit part for explosion protection and/or EMC measures
40 Sensor and/or actuator module
Is Measuring current
Uk Terminal voltage
Uv Voltage of the voltage source
Ue Input voltage at the voltage regulator
UM Voltage at the measuring resistor

1-9. (canceled)

10. An intrinsically safe automation field device for use in a potentially explosive area, comprising:
a first and a second connection terminal for connecting a two-wire line that can be used to supply a current;
a sensor and/or actuator module for capturing and/or setting a process variable;
an input/output module having a radio unit for wirelessly transmitting data; and
a main electronics module connected to the first and second connection terminals and designed separately from the input/output module, which carries the current that can be supplied via the two-wire line via a current path from the first to the second connection terminal,
wherein the main electronics module has a voltage regulator introduced into the current path which is designed to provide a power supply at least for the input/output module based on the supplied current,
wherein the main electronics module is further designed to transmit the process variable detected via the sensor element by setting the current to a corresponding value and/or to receive a process variable to be set by the actuator element by reading the current and to set the actuator element accordingly,
wherein the main electronics module further has an energy store that is designed to provide energy required for the radio unit for wirelessly transmitting data, and
wherein at least the energy store on the main electronics module is encapsulated using a potting compound.

11. The intrinsically safe automation field device according to claim 10, wherein the energy store includes at least one capacitor which has a capacitance of at least 10 μF.

12. The intrinsically safe automation field device according to claim 10, wherein the energy store is arranged in front of the voltage regulator on the main electronics module.

13. The intrinsically safe automation field device according to claim 10, wherein the input/output module further includes a current limiter or regulator which limits a current from the main electronics module to a value in the range of 0.1-100 mA.

14. The intrinsically safe automation field device according to claim 13, wherein the input/output module does not have a capacitor with a capacitance of greater than 100 μF.

15. The intrinsically safe automation field device according to claim 10, wherein the input/output module and the main electronics module are connected to one another via an electrical interface.

16. The intrinsically safe automation field device according to claim 15, wherein the input/output module is arranged in a cover of the field device.

17. The intrinsically safe automation field device according to claim 14, wherein the input/output module further includes a display for displaying information and/or for operating the field device.

18. The intrinsically safe automation field device according to claim 17, wherein the display is a color display.
